(19) United States
(12) Patent Application Publication
(10) Pub. No.: US 2013/0255258 A1
(43) Pub. Date: Oct. 3, 2013

(54) Rankine Cycle System

(71) Applicant: Ronald Lee Loveday, Corpus Christi, TX (US)

(72) Inventor: Ronald Lee Loveday, Corpus Christi, TX (US)

(21) Appl. No.: 13/834,842

(22) Filed: Mar. 15, 2013

Related U.S. Application Data
(60) Provisional application No. 61/619,280, filed on Apr. 2, 2012.

(51) Int. Cl. F02C 6/00

(52) U.S. Cl. CPC F02C 6/003
USPC 60/645; 60/643

(57) ABSTRACT

A method and apparatus for implementing the Rankine Cycle with improved efficiency through the use of thermal exchange between the working fluid and a brine liquid. In one embodiment, the brine liquid is further processed through a multistage flash distillation unit to produce distilled water or other minerals. Geothermal or exhaust waste heat may be used to further improve the Rankine Cycle efficiency, with remaining thermal energy improving the distillation process.

### CROSS-REFERENCE TO RELATED APPLICATIONS

This Application claims the benefit of U.S. Provisional Application 61/619,280 filed on Apr. 2, 2012, which is incorporated by reference in its entirety.

### TECHNICAL FIELD

The present disclosure relates generally to the Rankine Cycle systems and, more particularly, to methods and apparatus to increase the efficiency thereof.

### BACKGROUND OF THE DISCLOSURE

The well-known closed Rankine Cycle comprises a boiler or evaporator for the evaporation of a motive fluid, a turbine fed with vapor from the boiler to drive the generator or other load, a condenser for condensing the exhaust vapors from the turbine and a means, such as a pump, for recycling the condensed fluid to the boiler. Such a system is shown and described in U.S. Pat. No. 3,393,515.

Such Rankine Cycle systems are commonly used for the purpose of generating electrical power that is provided to a power distribution system, or grid, for residential and commercial use across the country. The motive fluid used in such systems is often water, with the turbine then being driven by steam. The source of heat to the boiler is generally a form of fossil fuel, e.g. oil, coal, natural gas, or nuclear power. The turbines in such systems are designed to operate at relatively high pressures and high temperatures and are relatively expensive in their manufacture and use.

As human consumption of energy increases, more attention has turned to renewable energy and conservation of energy, including reducing or reusing “waste heat” that was otherwise being lost to the atmosphere and, as such, was indirectly detrimental to the environment by requiring more fuel for power production than necessary. In addition to energy production concerns, water conservation is also an issue of mankind as the population increases and the demands for water increase by the growing population, energy production processes, and other technological advancements.

By the same token, world fresh water supplies have been dwindling, straining local populations once presented with abundant sources. As more and more fresh water rivers are over-tapped by growing populations and industry, their levels are falling, sparking these local populations to seek water from other sources. Many communities have ample access to non-freshwater sources, but purification has been cost-prohibitive. A need exists for a more efficient system of energy production and water purification.

### BRIEF SUMMARY OF THE DISCLOSURE

According to one aspect of the present disclosure, there are provided methods and apparatus to improve a Rankine Cycle system by increasing the temperature difference throughout the cycle, thereby improving the efficiency of the Rankine Cycle equipment. This increase in efficiency allows for more power production at a given input temperature and/or provides for power production at a lower temperature. According to another aspect of the present disclosure, a brine fluid used in the system of the present disclosure is also processed to provide a source of distilled water for public or commercial use.

In one embodiment, the temperature difference throughout the Rankine Cycle is increased by transferring excess heat to a brine fluid acquired from a sea, gulf, surface, or subsurface resource for brine fluid. The brine fluid is heated through a heat exchange process with the waste heat. The heated brine fluid is then passed to a multistage flash distillation unit where the heated brine fluid can be decompressed, thereby lowering the boiling point of the brine fluid, which causes the water to vaporize. The water is condensed within each stage of the multistage flash distillation unit and output as fresh water. There is a byproduct salt slurry that can be disposed of or used in other industries such as oil and gas industries for the purpose of weighting drilling mud. The slurry can also be processed for minerals and sold in the market.

According to another aspect, the present disclosure provides a Rankine Cycle system comprising: a first heat exchanger configured to facilitate thermal energy transfer from a heated fluid to a working fluid, a turbine coupled to a generator, said turbine is configured to receive the working fluid from the first heat exchanger; wherein said generator is configured to generate electricity at least in response to the receipt of the working fluid by the turbine; a second heat exchanger configured to facilitate thermal energy transfer from the working fluid flowing from an output of the turbine to a brine liquid; a multistage flash distillation unit configured to produce distilled water from the brine liquid flowing from an output of the second heat exchanger.

In one embodiment, at least a portion of the heated fluid comes from a geothermal source. In another embodiment, at least a portion of the heated fluid comes from waste heat. This waste heat may be from sources such as exhaust from an industrial plant, or exhaust from other generators. In yet another embodiment, at least a portion of the heated fluid from an output of the first heat exchanger is routed to an injection well. In another embodiment, at least a portion of the brine liquid from an output of the multistage flash distillation unit is routed to an injection well. In yet another embodiment, at least a portion of the brine liquid from an output of the multistage flash distillation unit is processed to retrieve at least one mineral.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are drawn to scale for certain embodiments (unless otherwise noted), meaning the sizes of the depicted elements are accurate relative to each other for at least the depicted embodiment.

FIG. 1 shows a conventional ankine Cycle system;

FIG. 2 shows another conventional Rankine Cycle system;

FIG. 3 shows an exemplary embodiment of a Rankine Cycle system according to the aspects of the present disclosure;

FIG. 4 shows an another embodiment of a Rankine Cycle system according to the aspects of the present disclosure;

FIG. 5 shows an another embodiment of a Rankine Cycle system according to the aspects of the present disclosure;

FIG. 6 shows an another embodiment of a Rankine Cycle system according to the aspects of the present disclosure;

FIG. 7 shows an another embodiment of a Rankine Cycle system according to the aspects of the present disclosure;

FIG. 8 shows an another embodiment of a Rankine Cycle system according to the aspects of the present disclosure;

FIG. 9 shows an another embodiment of a Rankine Cycle system according to the aspects of the present disclosure;

FIG. 10 shows an another embodiment of a Rankine Cycle system according to the aspects of the present disclosure;

### DETAILED DESCRIPTION OF THE DISCLOSURE

As used herein, “a” and “an” means one or more than one unless otherwise stated.

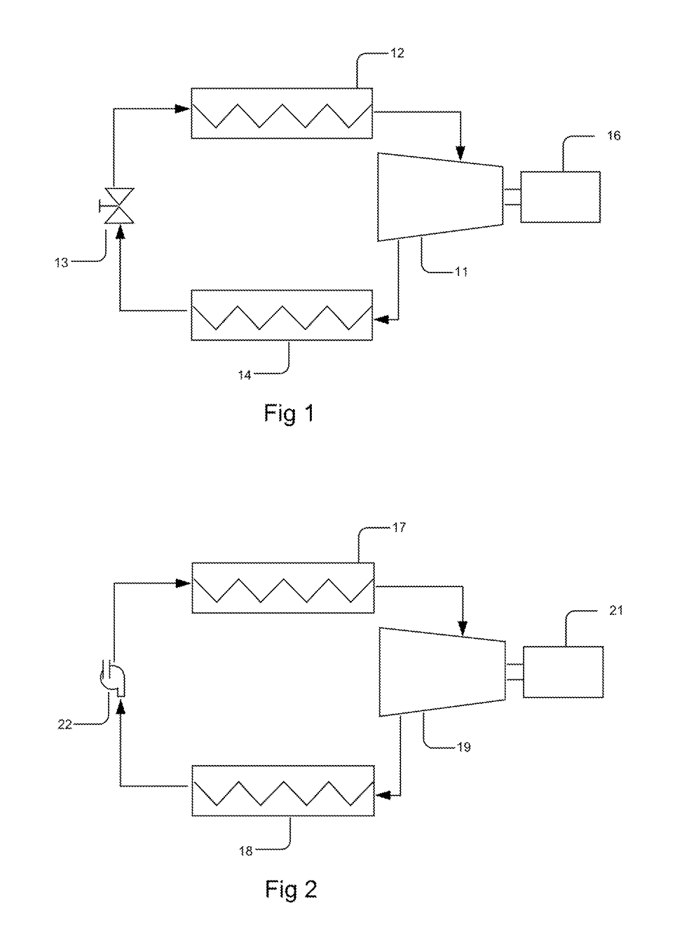

Referring now to FIG. 1, a typical vapor compression cycle is shown as comprising, in serial flow relationship, a compressor 11, a condenser (sometimes called a hot side heat exchanger) 12, a throttle valve (also known as an expansion valve) 13, and an evaporator/cooler (sometimes called a cold side heat exchanger) 14. FIG. 1 shows a typical set up of a Rankine Cycle system. The typical working fluid includes water. However, different working fluids can be used to flow through the system as indicated by the arrows. In an Organic Rankine Cycle (ORC), instead of the water or steam, the ORC system vaporizes an organic fluid, characterized by a molecular mass higher than water, which leads to a slower rotation of the turbine and lower pressure and erosion of the metallic parts and blades. Further, the high molecular mass fluid has a liquid-vapor phase change, or boiling point, occurring at a lower temperature than the water-steam phase change, thereby allowing for the recovery of energy from lower heat temperature resources, such as low-temperature geothermal sources, waste heat from various industrial plants, exhaust from generators, etc.

The compressor 11 which is driven by a motor 16 receives working fluid vapor from the evaporator/cooler 14 and compresses it to a higher temperature and pressure, with the relatively hot vapor then passing to the condenser 12 where it is cooled and condensed to a liquid state by a heat exchange relationship with a cooling medium such as air or water. The liquid working fluid then passes from the condenser to a throttle valve wherein the working fluid is expanded to a lower temperature two-phase liquid/vapor state as it passes to the evaporator/cooler 14. Expansion of the compressed working fluid releases energy, thereby cooling the fluid. This expanded working fluid, therefore, provides a cooling effect to air or water passing through the evaporator/cooler 14. The low pressure vapor then passes to the compressor 11, where the cycle is again commenced.

Another typical Rankine Cycle system as shown in FIG. 2 also includes an evaporator/boiler 17 and a condenser 18 which, respectively, receives and dispenses heat in the same manner as in the vapor compression cycle as described hereinabove. However, as will be seen, the direction of fluid flow within the system is reversed from that of the vapor compression cycle, and the compressor 11 is replaced with a turbine 19 which, rather than being driven by a motor 16 is driven by the motive fluid in the system, and in turn drives a generator 21 that produces power.

In operation, the evaporator which is commonly a boiler having a significant heat input, vaporizes the motive fluid, which can be water, a fluid with a boiling point less than water, or any other refrigerant. The vapor then passes to the turbine for providing motive power thereto. Upon leaving the turbine, the low pressure vapor passes to the condenser 18 where it is condensed by way of a heat exchange relationship with a cooling medium. The condensed liquid is then circulated to the evaporator by a pump 22 as shown to complete the cycle.

One of the concerns with the Rankine Cycle as shown in FIG. 2 relates to back pressure. Pressure applied to the working fluid at the exit point of the turbine is dictated by the cooling rate of the condenser. Air-cooled or evaporative-cooled condensers depend on ambient temperature and humidity. During periods of high ambient temperature or humidity, the condenser efficiency may be reduced, resulting in higher back pressure on the turbine and less efficiency over the entire Rankine Cycle system. Likewise, condenser efficiency regulates the state of the working fluid at the pump. Back work ratio, the fraction of the work produced by the turbine that is used by the pump, should be kept to a minimum. It is important, therefore, that the pump feed be a saturated liquid or even a slightly subcooled liquid.

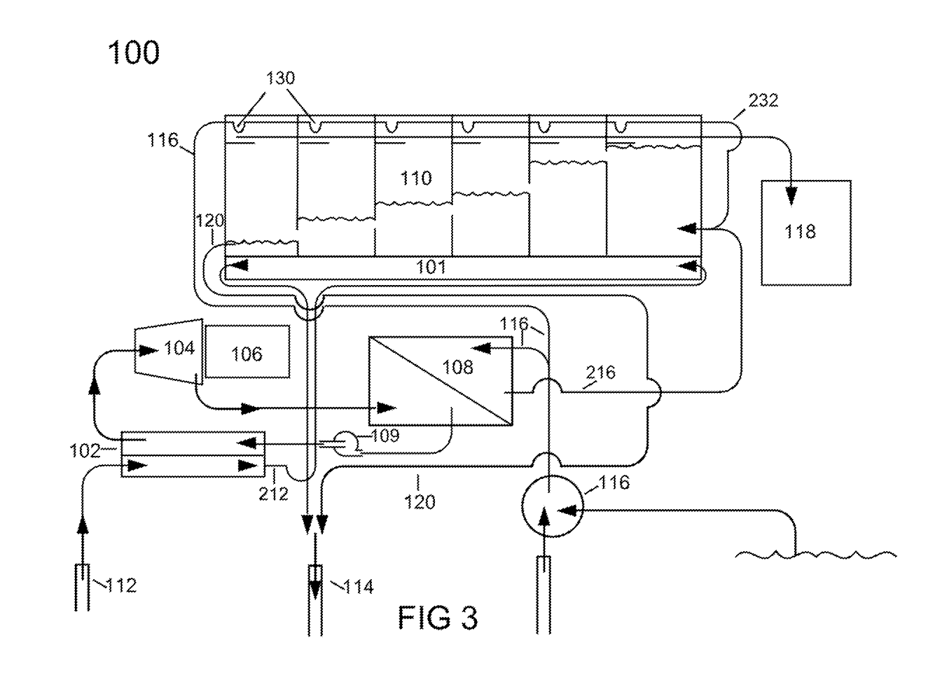

FIG. 3 illustrates system 100, an exemplary embodiment according to the aspects of the present disclosure. System 100 includes heat exchanger 102, turbine 104 coupled to generator 106, heat exchanger 108, and multistage flash distillation unit 110. System 100 replaces the evaporator/cooler 14 or evaporator/boiler 17 and condensers 12 and 18 of the conventional systems in FIGS. 1 and 2 with counter-current flow heat exchangers 102 and 108. The input into system 100 includes heated fluid from geothermal source 112. The heated fluid from the geothermal source may, for instance, be about 300 degrees F. Other geothermal source temperatures may apply. In the warmer southwest region of the United States, for example, the range may be from 200 F to 450 F. In the cooler north, the applicable range may be lower. A person skilled in the art would understand that the applicable ranges of source heat are a function of the overall temperature differential of the Rankine Cycle system, dependent on the inlet temperature of the corresponding cold brine source as described below.

The heated fluid enters heat exchanger 102 to heat up the working fluid of system 100. In the preferred embodiment, the heated fluid from geothermal source 112 and the working fluid of system 100 flow through heat exchanger 102 in a counter-current direction. In other embodiments, the fluids may flow in the same direction so long as the heat transfer occurs between the heated fluid from geothermal source 112 and the working fluid of system 100. The working fluid of system 100 can be water, a fluid with a boiling point less than water, or other suitable working fluids used in a typical Organic Rankine Cycle system.

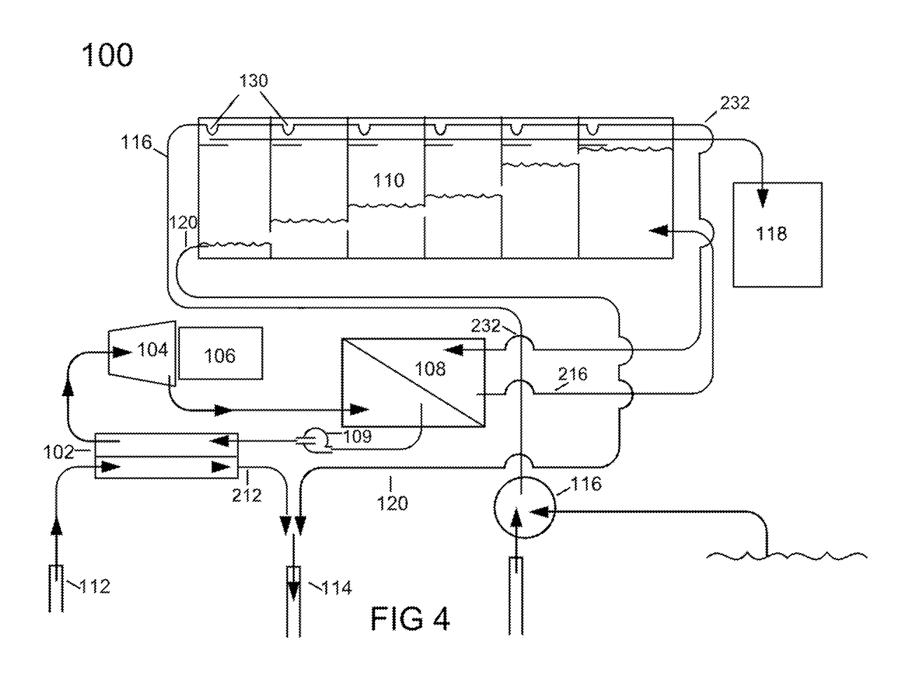

Once the fluid heated at least by geothermal source 112 passes through heat exchanger 102 and transfers thermal energy to the working fluid of system 100, it can be directed to a low pressure injection well, such as well 114, as seen in FIG. 4. The injection well may be directed back into the geothermal source formation, to a cold brine source, or to another formation. In addition, two injection wells are contemplated, one for the heated fluid ejected from heat exchanger 102 and one for the available cold brine ejected from heat exchanger 108 (discussed below).

In other embodiments, various applications of the non-working fluid exiting heat exchange 102 are contemplated. For instance, the fluid can be routed to a desalination process to produce fresh water such as that described for multistage flash distillation unit 110. The working fluid that is heated by the fluid from geothermal source 112 exits heat exchanger 102 and drives turbine 104 to generate electricity by way of generator 106. Next, the working fluid exits turbine 104 and enters heat exchanger 108 where it is cooled by brine 116 at a sufficiently low temperature, such as about 65 degrees F. or lower. Other brine temperatures are contemplated. Brine 116, which may come from a variety of sources such as the sea, gulf, bay, lake or subsurface resources, enters heat exchanger 108 to absorb the heat away from the working fluid of system 100. The cooled working fluid exits heat exchange 108, traverses pump 109, and enters heat exchange 102 to repeat the cycle again.

A person skilled in the art would understand that the applicable range of brine temperatures is dependent on the temperature differential between the working fluid temperature and said brine temperature. To maximum pump efficiency, the working fluid should be cooled to at least about a saturated liquid, preferably slightly subcooled, in order to maximize pump efficiency and minimize back pressure on the turbine. Cooling requirements are thus dictated by the thermodynamic properties of the working fluid and the temperature differential between the heating fluid and the cooling fluid. In one embodiment, the heating fluid is produced from geothermal source 112 at about 300 F and the cooling fluid is brine 116 entering the system at about 65 F or lower. In another embodiment, the heating fluid may enter the system at about 215 F and the cooling fluid enters the system at about 35 F. In still another embodiment, the heat source may be significantly higher, for example at about 700 F or above, while the cooling fluid can also be higher, such as about 100 F. The efficiency of the system is improved by a greater temperature differential between the heat source and the cooling fluid and one skilled in the art would understand that available temperature ranges may be dictated at least by region, season, and weather.

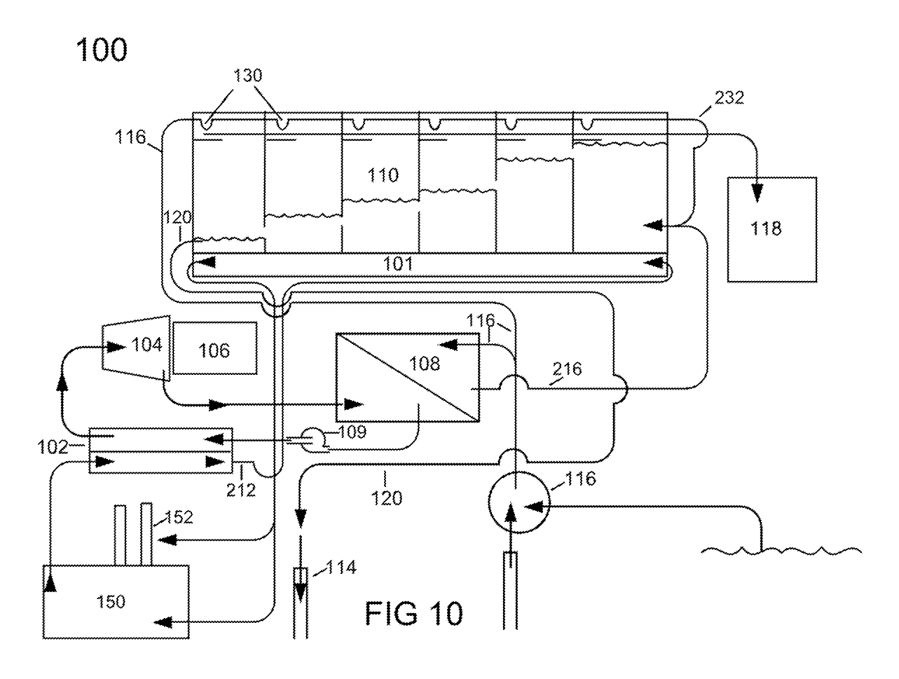

In one embodiment, the working fluid may be heated by waste heat sources, such as exhaust from industrial plants, generators, etc. FIG. 10 is illustrative. Waste heat is provided by the waste heat source 150 to heat exchanger 102. Thermal energy is transferred to the working fluid of the Rankine Cycle system. Once the fluid heated at least by waste heat source 150 passes through heat exchanger 102 and transfers thermal energy to the working fluid of system 100, it can be directed to back into the waste heat source 150 or exhausted into the atmosphere via stack 152. It may also be directed into the multistage distillation unit, according to FIG. 3.

Referring now to FIG. 3, cool brine 116 may have multiple uses. In the exemplary embodiment, cool brine 116 is routed into heat exchanger 108 where heat is transferred from the working fluid having just exited turbine 104. The exchange of heat from the working fluid to brine 116 improves the efficiency of system 100, allowing for more power production at a given temperature by at least reducing back pressure on the turbine and by reducing the back work ratio of the system. In addition, improved cooling capacity provides for production at a lower heating fluid temperature.

Multistage flash distillation unit 110 separates H2O molecules from the salts, dissolved solids, liquids, or gases in brine 116 through vaporization of brine 116 at reduced temperatures in lower pressure. The vapor condenses to form fresh water. In the low pressure environment of multistage flash distillation unit 110, the boiling point of water is lower, which requires less energy to vaporize the brine liquid.

Brine 216 exiting heat exchanger 108 has been heated by the working fluid of system 100. When the heated brine 216 enters the first chamber which is at a lower pressure, at least a portion of brine 216 flashes to vapor because the temperature of the heated brine 216 is higher than the boiling temperature of water at that pressure. In the exemplary embodiment, the steam rises to the upper part of the chamber and condenses when it contacts condensing coils 130 to form distilled water 118 free of salts and other impurities. The brine then moves into subsequent stage chambers where the pressure is lower than the prior stage. Each stage flashes more brine to vapor.

Vapor is condensed on cooling fingers 130, which are generally heat exchanger tubes containing a cooler fluid. In the exemplary embodiment, fluid in cooling fingers 130 is brine 116. Cool brine 116 is also routed from the available cool brine source to the multistage flash distillation unit 110 to provide a source of cool fluid for cooling fingers 130. The cool brine 116 is also heated as it traverses multistage flash distillation unit 110, becoming heated brine 232. In one embodiment, heated brine 232 joins or replaces heated brine 216 as the fluid to be decompressed and vaporized in the multistage flash distillation unit 110.

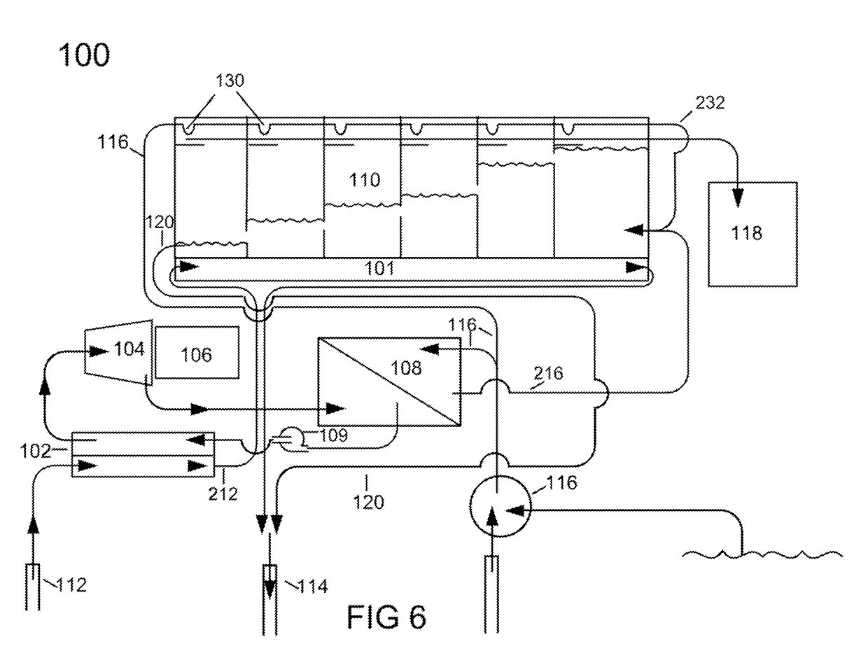

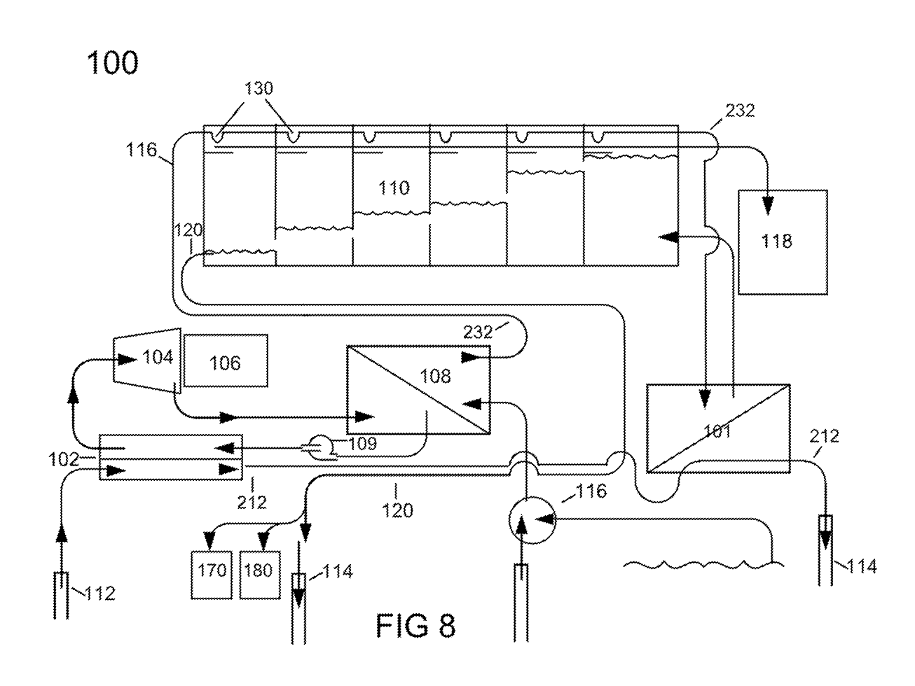

Heated fluid 212 exits heat exchanger 102 with remaining thermal energy. To maximize the efficiency of system 100, heated fluid 212 may be further routed to heat exchanger 101 located at multistage flash distillation unit 110. In the embodiment shown in FIG. 3, heat exchanger 101 is located inside and at the bottom of multistage flash distillation unit 110. A person skilled in the art would understand that heat exchanger 101 could be located independently outside of multistage flash distillation unit 110 as seen in FIG. 8, so long as it interacts with the flash unit input brine, in this embodiment heated brine 232 and/or heated brine 216. A person skilled in the art would also recognize that heated fluid 212 could traverse heat exchanger 101 in either direction, depending on whether the designer prefers to provide more heat to the lower pressure or the higher pressure chambers of multistage flash distillation unit 110. Compare FIG. 3 to FIG. 6. In the alternative, heated fluid 212 may be parsed into separate cells so that heated fluid 212 enters each chamber at the same temperature (not shown). Cool brine 116 may also be parsed into separate cells so that cool brine 116 enters each chamber at the same temperature (not shown).

As water vapor rises to the top of multistage flash distillation unit 110, it condenses against cooling fingers 130 to form distilled water 118. This distilled water 118 can provide a source of fresh water for public or commercial use. Brine slurry 120 exits multistage flash unit 110 to be disposed. Brine slurry 120 has several commercial uses. It can be provided to the oil drilling industry as raw materials for drilling mud, it can be processed for minerals that are sold in the appropriate market, or it can also be injected into well 114, directed either to the original brine formation, a geothermal formation, or an alternate formation.

FIG. 4 demonstrates another embodiment according to the present disclosure. Cool brine 116 traverses multistage flash distillation unit 110, providing cooling for condensation purposes through cooling fingers 130. Brine exits multistage flash distillation unit 110 as brine 232, where it is routed to heat exchanger 108. Brine 232 absorbs additional thermal energy from the working fluid of system 100, thereby improving pump efficiency and reducing back pressure on the turbine. Heated brine 216 exits heat exchanger 108 to be used as the brine input to multistage flash distillation unit 110. In this capacity, heat exchanger 108 acts as the heat source for multistage flash unit 110.

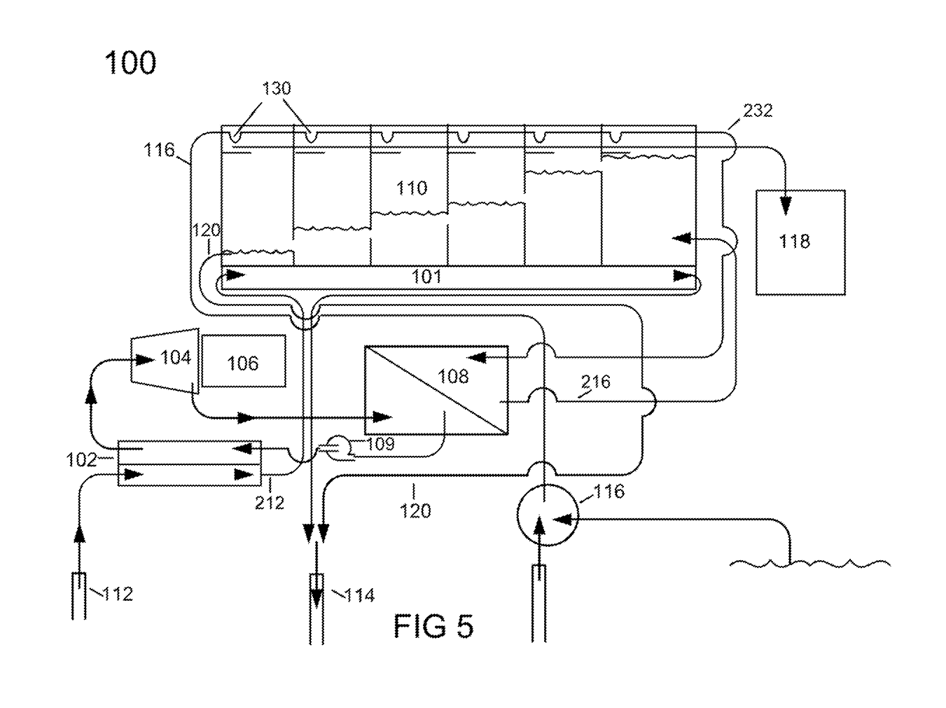

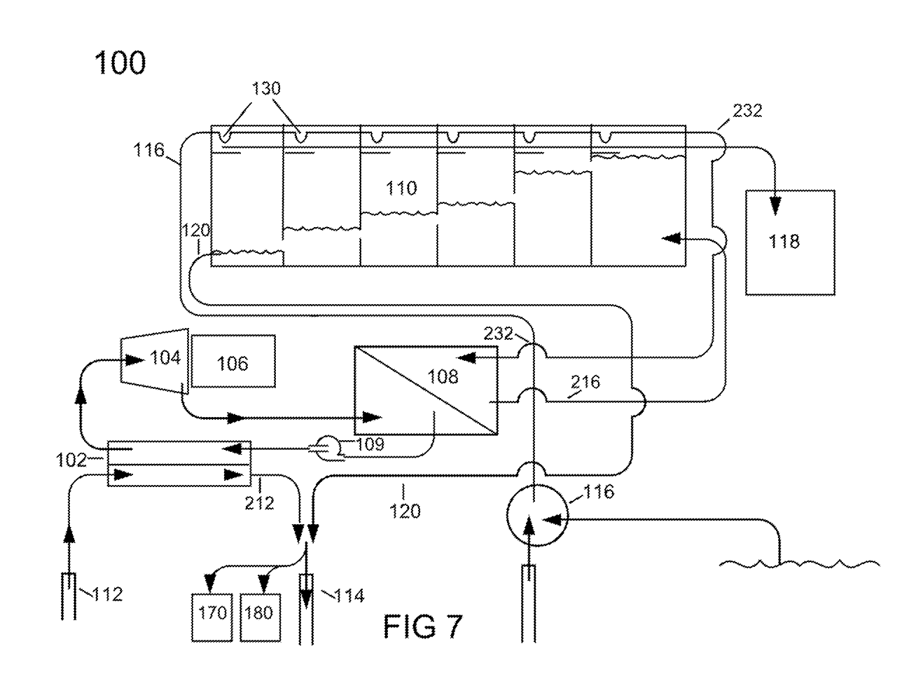

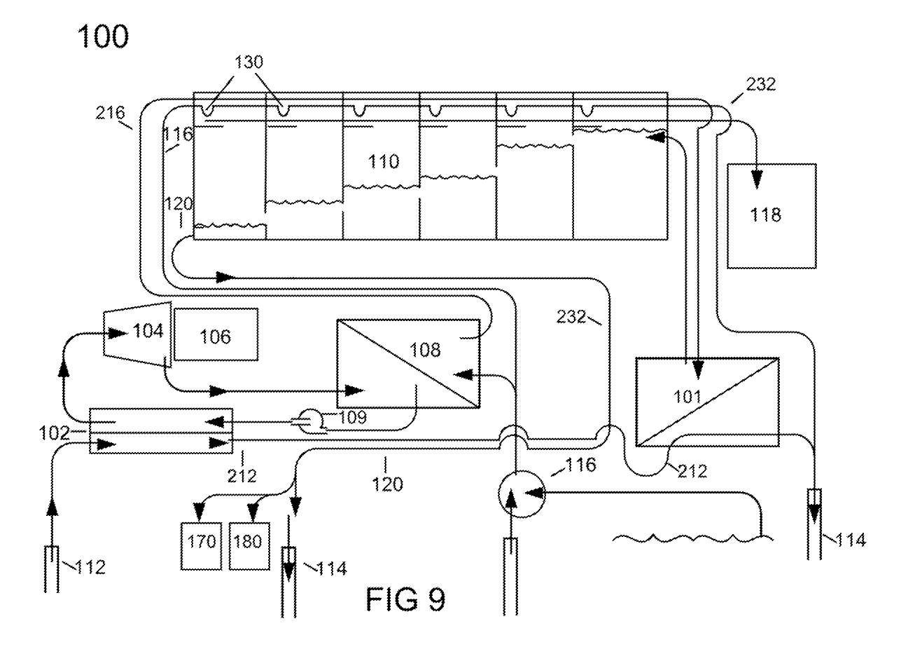

An additional heat source for multistage flash unit 110 may be found from geothermal source 112, as exemplified in FIG. 5. Heated source fluid 212 exits heat exchanger 102 with remaining thermal energy. To maximize the efficiency of system 100, heated fluid 212 may be further routed to heat exchanger 101 located at multistage flash distillation unit 110 as described above. The amount of cooling necessary to maximize the overall efficiency of system 100 by way of back pressure reduction and pump efficiency may be regulated by the flow level of cool brine 116. Increased flow of cool brine 116 would provide ample cooling for multistage flash distillation unit 110 condensation purposes while still maintaining cool resources for heat removal in heat exchanger 108. Additional embodiments of the device shown in system 100 are contained in FIGS. 7-9.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A Rankine Cycle system comprising:
a first heat exchanger configured to facilitate thermal energy transfer from a heated fluid to a working fluid,
a turbine coupled to a generator, said turbine is configured to receive the working fluid from the first heat exchanger;
a second heat exchanger configured to facilitate thermal energy transfer from the working fluid flowing from an output of the turbine to a brine liquid; and
a multistage flash distillation unit configured to produce distilled water from the brine liquid flowing from an output of the second heat exchanger.

2. The Rankine Cycle system of claim 1 wherein at least a portion of the heated fluid comes from a geothermal source.

3. The Rankine Cycle system of claim 1 wherein at least a portion of the heated fluid from an output of the first heat exchanger provides thermal energy to the multistage flash distillation unit.

4. The Rankine Cycle system of claim 1 wherein the multistage flash distillation unit further comprises cooling fingers sourced at least in part from the brine fluid.

5. The Rankine Cycle system of claim 1 wherein at least a portion of the heated fluid from an output of the first heat exchanger is routed to an injection well.

6. The Rankine Cycle system of claim 1 wherein at least a portion of the brine liquid from an output of the multistage flash distillation unit is routed to an injection well.

7. The Rankine Cycle system of claim 1 wherein at least a portion of the brine liquid from an output of the multistage flash distillation unit is processed to retrieve at least one mineral.

8. The Rankine Cycle system of claim 1 wherein at least a portion of the heated fluid comes from exhaust waste heat.

9. The Rankine Cycle system of claim 8 wherein the source of exhaust waste heat is an industrial plant.

10. A method for improving a Rankine Cycle system comprising:
receiving a heated fluid into a first heat exchanger;
heating a working fluid in the first heat exchanger;
driving a turbine coupled to a generator;
receiving a cool brine into a second heat exchanger;
transferring heat from the working fluid to the cool brine to create heated brine;
transferring the heated brine into a multistage flash distillation unit;
decompressing at least part of the heated brine into vapor; and
condensing the vapor on cooling fingers sourced by cool fluid.

11. The method of claim 10 further comprising collecting the condensed vapor.

12. The method of claim 10 wherein at least a portion of the heated fluid comes from a geothermal source.

13. The method of claim 10 wherein at least a portion of the heated fluid comes from waste heat.

14. The method of claim 10 further comprising introducing additional heated fluid into the multistage flash distillation unit, wherein the heat from the additional heated fluid is transferred to the heated brine.

15. The method of claim 10 further comprising processing the heated brine to retrieve at least one mineral.

16. The method of claim 10 further comprising injecting at least a portion of the heated brine output from the multistage flash distillation unit into an injection well.
